(19) United States
(12) Patent Application Publication
(10) Pub. No.: US 2025/0086802 A1
(43) Pub. Date: Mar. 13, 2025

(54) DETECTION OF OBJECTS IN LIDAR POINT CLOUDS

(71) Applicant: TuSimple, Inc., SAN DIEGO, CA (US)

(72) Inventors: Dongqiangzi YE, San Diego, CA (US); Zixiang ZHOU, San Diego, CA (US); Weijia CHEN, San Diego, CA (US); Yufei XIE, San Diego, CA (US); Yu WANG, San Diego, CA (US); Panqu WANG, San Diego, CA (US); Lingting GE, San Diego, CA (US)

(21) Appl. No.: 18/434,501

(22) Filed: Feb. 6, 2024

Related U.S. Application Data
(60) Provisional application No. 63/582,314, filed on Sep. 13, 2023.

(51) Int. Cl. G06T 7/10; G06T 9/00; G06T 17/00

(52) U.S. Cl. CPC G06T 7/10; G06T 9/00; G06T 17/00; G06T 2207/10028; G06T 2207/20081; G06T 2207/20084; G06T 2207/30252; G06T 2210/56

(57) ABSTRACT

A method of processing point cloud information includes converting points in a point cloud obtained from a lidar sensor into a voxel grid, generating, from the voxel grid, sparse voxel features by applying a multi-layer perceptron and one or more max pooling layers that reduce dimension of input data; applying a cascade of an encoder that performs a N-stage sparse-to-dense feature operation, a global context pooling (GCP) module, and an M-stage decoder that performs a dense-to-sparse feature generation operation. The GCP module bridges an output of a last stage of the N-stages with an input of a first stage of the M-stages, where N and M are positive integers. The GCP module comprises a multi-scale feature extractor; and performing one or more perception operations on an output of the M-stage decoder and/or an output of the GCP module.

### CROSS-REFERENCE TO RELATED APPLICATIONS

This application claims priority to and the benefit of U.S. Provisional Application No. 63/582,314, filed on Sep. 13, 2023. The aforementioned application of which is incorporated herein by reference in its entirety.

### TECHNICAL FIELD

This document relates to tools (systems, apparatuses, methodologies, computer program products, etc.) for point cloud information processing.

### BACKGROUND

Recently, light ranging and detection (lidar) technology has become commercially available for automotive use. A vehicle may be installed with one or more lidars that capture point cloud information of area around the vehicle. The point cloud data may be processed and used for vehicular tasks such as navigation.

### SUMMARY

Disclosed are devices, systems and methods for analyzing point cloud data to detect objects in the point cloud data.

In one aspect, a disclosed method includes converting points in a point cloud obtained from a lidar sensor into a voxel grid, generating, from the voxel grid, sparse voxel features by applying a multi-layer perceptron and one or more max pooling layers that reduce dimension of input data, applying a cascade of an encoder that performs a N-stage sparse-to-dense feature operation, a global context pooling (GCP) module, and an M-stage decoder that performs a dense-to-sparse feature generation operation, wherein the GCP module bridges an output of a last stage of the N-stages with an input of a first stage of the M-stages, where N and M are positive integers; and wherein the GCP module comprises a multi-scale feature extractor; and performing one or more perception operations on an output of the M-stage decoder and/or an output of the GCP module.

In another aspect, another disclosed method includes generating a three-dimensional perception output from the point cloud data by processing the point cloud data through a cascade of 3 stages, wherein the cascade includes a first stage in which the point cloud data is encoded from a sparse representation to a dense representation, a second stage in which features are extracted from the dense representation using a long-range contextual information to identify the features; and a third stage in which the dense representation is transformed into a sparse representation from which the three-dimensional perception output is generated

In another aspect, a disclosed apparatus includes one or more processors configured to implement the above-recited method.

In another aspect, an autonomous vehicle comprising a lidar sensor to obtain a point cloud data and one or more processors configured to process the point cloud data using the above-recited method is disclosed.

In another exemplary aspect, the above-described method is embodied in a non-transitory computer readable storage medium. The non-transitory computer readable storage medium includes code that when executed by a processor, causes the processor to perform the methods described in this patent document.

In yet another exemplary embodiment, a device that is configured or operable to perform the above-described methods is disclosed.

The above and other aspects and features of the disclosed technology are described in greater detail in the drawings, the description and the claims.

### BRIEF DESCRIPTION OF THE DRAWINGS

FIG. 1 is an example of a vehicular computational platform.

FIG. 2 is a flowchart for an example method of detecting objects in a point cloud.

FIGS. 3A-3D depict examples of point cloud and segmentation thereof.

FIG. 4 is a block diagram of workflow according to some embodiments.

FIG. 5 is a block diagram of GCP.

FIG. 6 is a block diagram of an example second stage of an object detection pipeline.

FIG. 7 shows example outputs of the second stage refinement. The segmentation consistency of points of the thing objects can be improved by the 2nd stage.

FIG. 8 shows Table 1 of Waymo Open Dataset Semantic Segmentation Leaderboard. Our LidarMultiNet reached the highest mIoU (intersection over union) of 71.13 and achieved the best accuracy on 15 out of the 22 classes. y: without TTA and model ensemble.

FIG. 9 shows Table 2: Ablation studies for 3D semantic segmentation on the WOD validation set. We show the improvement introduced by each component compared to our LidarMultiNet base network.

FIG. 10 shows Table 3 Single-model detection performance comparisons on Waymo test set. “L” indicates LiDAR-only, and “CL” denotes camera and LiDAR fusion.

FIG. 11 shows Table 4: Detection performance comparisons on Waymo validation set. “L” indicates LiDAR-only, and “CL” denotes camera and LiDAR fusion.

FIG. 12 shows Table 5: Comparison of the first-stage result of the jointly trained model and independently trained single-task models.

FIG. 13 shows Table 6: Comparison with state-of-the-art methods on the test sets of three nuScenes benchmarks. A single LidarMultiNet model is used to generate predictions for all three tasks.

FIG. 14 shows Table 7: Comparison with state-of-the-art methods on the validation sets of three nuScenes benchmarks.

FIG. 15 shows Table 8: Improvements of the 2nd-stage segmentation refinement on the nuScenes semantic segmentation and panoptic segmentation validation sets.

FIG. 16 shows Table 9: Implementation details of the LidarMultiNet.

FIG. 17 is a flowchart for a method of performing perception of a point cloud data obtained from a lidar.

### DETAILED DESCRIPTION

Section headings are used in the present document for ease of cross-referencing and improving readability and do not limit scope of disclosed techniques. Furthermore, various image processing techniques have been described by using examples of self-driving vehicle platform as an illustrative example, and it would be understood by one of skill in the art that the disclosed techniques may be used in other operational scenarios also (e.g., surveillance, medical image analysis, image search cataloguing, etc.).

The transportation industry has been undergoing considerable changes in the way technology is used to control vehicles. A semi-autonomous and autonomous vehicle is provided with a sensor system including various types of sensors to enable a vehicle to operate in a partially or fully autonomous mode.

### 1. Initial Discussion

LiDAR-based 3D object detection, semantic segmentation, and panoptic segmentation are usually implemented in specialized networks with distinctive architectures that are difficult to adapt to each other. This paper presents various embodiments of a LiDAR-based multi-task network, called LidarMulti-Net. In one example aspect, an embodiment unifies these three major LiDAR perception tasks. Among its many benefits, a multi-task network can reduce the overall cost by sharing weights and computation among multiple tasks. However, it typically underperforms compared to independently combined single-task models. The proposed LidarMultiNet aims to bridge the performance gap between the multi-task network and multiple single-task networks. At the core of LidarMultiNet is a strong 3D voxel-based encoder-decoder architecture with a Global Context Pooling (GCP) module extracting global contextual features from a LiDAR frame. Task-specific heads are added on top of the network to perform the three LiDAR perception tasks. More tasks can be implemented simply by adding new task-specific heads while introducing little additional cost. A second stage is also proposed to refine the first-stage segmentation and generate accurate panoptic segmentation results. LidarMultiNet is extensively tested on both Waymo Open Dataset and nuScenes dataset, demonstrating for the first time that major LiDAR perception tasks can be unified in a single strong network that is trained end-to-end and achieves state-of-the-art performance. Notably, LidarMultiNet reaches the official 1^{st} place in the Waymo Open Dataset 3D semantic segmentation challenge 2022 with the highest mIoU and the best accuracy for most of the 22 classes on the test set, using only LiDAR points as input. It also sets the new state-of-the-art for a single model on the Waymo 3D object detection benchmark and three nuScenes benchmarks.

### 2. Example Vehicular Computational Platform

One example use of the proposed method is in the field of autonomous vehicle navigation. In such an implementation, the object detection performed according to disclosed technology may be used to plan future trajectory of the autonomous vehicle.

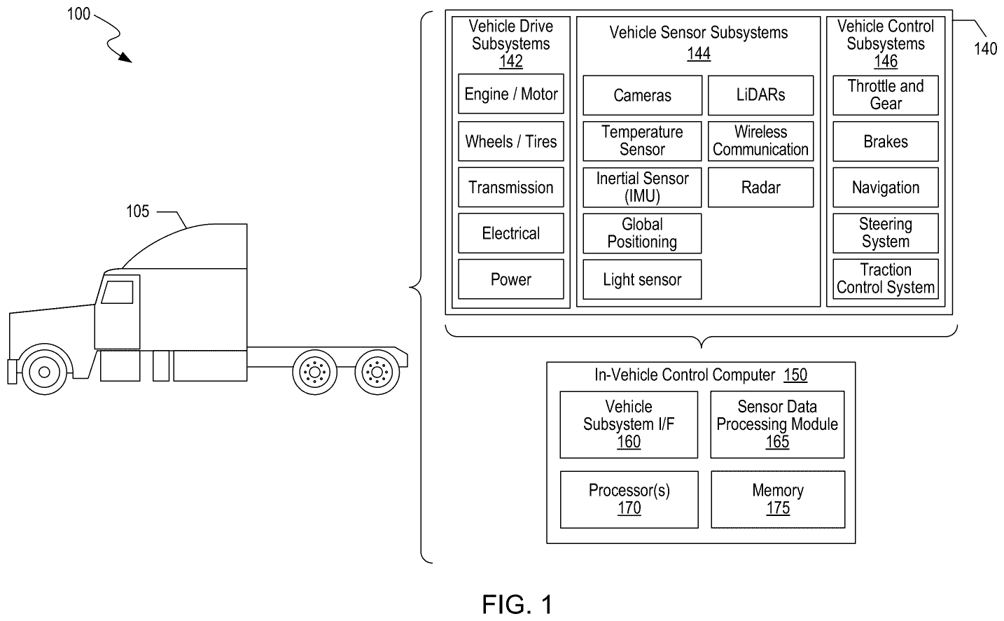

FIG. 1 shows a system 100 that is included by an autonomous (self-driving) or semi-autonomous vehicle 105. The vehicle 105 includes a plurality of vehicle subsystems 140 and an in-vehicle control computer 150. The plurality of vehicle subsystems 140 includes vehicle drive subsystems 142, vehicle sensor subsystems 144, and vehicle control subsystems. An engine or motor, wheels and tires, a transmission, an electrical subsystem, and a power subsystem may be included in the vehicle drive subsystems. The engine of the vehicle 105 may be an internal combustion engine, a fuel-cell powered electric engine, a battery powered electrical engine, a hybrid engine, or any other type of engine capable of moving the wheels on which the vehicle 105 moves. The vehicle 105 has multiple motors or actuators to drive the wheels of the vehicle, such that the vehicle drive subsystems 142 include two or more electrically driven motors. The transmission may include a continuous variable transmission or a set number of gears that translate the power created by the engine into a force that drives the wheels of the vehicle. The vehicle drive subsystems may include an electrical system that monitors and controls the distribution of electrical current to components within the system, including pumps, fans, and actuators. The power subsystem of the vehicle drive subsystem may include components that regulate the power source of the vehicle.

Vehicle sensor subsystems 144 can include sensors for general operation of the vehicle 105, including those which would indicate a malfunction in the AV or another cause for an AV to perform a limited or minimal risk condition (MRC) maneuver. The sensors for general operation of the vehicle may include cameras, a temperature sensor, an inertial sensor (IMU), a global positioning system, a light sensor, a LIDAR system, a radar system, and wireless communications supporting network available in the vehicle 105.

The in-vehicle control computer 150 can be configured to receive or transmit data from/to a wide-area network and network resources connected thereto. A web-enabled device interface (not shown) can be included in the vehicle 105 and used by the in-vehicle control computer 150 to facilitate data communication between the in-vehicle control computer 150 and the network via one or more web-enabled devices. Similarly, a user mobile device interface can be included in the vehicle 105 and used by the in-vehicle control system to facilitate data communication between the in-vehicle control computer 150 and the network via one or more user mobile devices. The in-vehicle control computer 150 can obtain real-time access to network resources via network. The network resources can be used to obtain processing modules for execution by processor 170, data content to train internal neural networks, system parameters, or other data. In some implementations, the in-vehicle control computer 150 can include a vehicle subsystem interface (not shown) that supports communications from other components of the vehicle 105, such as the vehicle drive subsystems 142, the vehicle sensor subsystems 144, and the vehicle control subsystems 146.

The vehicle control subsystem 146 may be configured to control operation of the vehicle, or truck, 105 and its components. Accordingly, the vehicle control subsystem 146 may include various elements such as an engine power output subsystem, a brake unit, a navigation unit, a steering system, and an autonomous control unit. The engine power output may control the operation of the engine, including the torque produced or horsepower provided, as well as provide control of the gear selection of the transmission. The brake unit can include any combination of mechanisms configured to decelerate the vehicle 105. The brake unit can use friction to slow the wheels in a standard manner. The brake unit may include an Anti-lock brake system (ABS) that can prevent the brakes from locking up when the brakes are applied. The navigation unit may be any system configured to determine a driving path or route for the vehicle 105. The navigation unit may additionally be configured to update the driving path dynamically while the vehicle 105 is in operation. In some embodiments, the navigation unit may be configured to incorporate data from the GPS device and one or more predetermined maps so as to determine the driving path for the vehicle 105. The steering system may represent any combination of mechanisms that may be operable to adjust the heading of vehicle 105 in an autonomous mode or in a driver-controlled mode.

The autonomous control unit may represent a control system configured to identify, evaluate, and avoid or otherwise negotiate potential obstacles in the environment of the vehicle 105. In general, the autonomous control unit may be configured to control the vehicle 105 for operation without a driver or to provide driver assistance in controlling the vehicle 105. In some embodiments, the autonomous control unit may be configured to incorporate data from the GPS device, the RADAR, the LiDAR (also referred to as LIDAR), the cameras, and/or other vehicle subsystems to determine the driving path or trajectory for the vehicle 105. The autonomous control unit may activate systems to allow the vehicle to communicate with surrounding drivers or signal surrounding vehicles or drivers for safe operation of the vehicle.

An in-vehicle control computer 150, which may be referred to as a VCU (vehicle control unit), includes a vehicle subsystem interface 160, a driving operation module 168, one or more processors 170, a compliance module 166, a memory 175, and a network communications subsystem (not shown). This in-vehicle control computer 150 controls many, if not all, of the operations of the vehicle 105 in response to information from the various vehicle subsystems 140. The one or more processors 170 execute the operations that allow the system to determine the health of the AV, such as whether the AV has a malfunction or has encountered a situation requiring service or a deviation from normal operation and giving instructions. Data from the vehicle sensor subsystems 144 is provided to in-vehicle control computer 150 so that the determination of the status of the AV can be made. The compliance module 166 determines what action needs to be taken by the vehicle 105 to operate according to the applicable (i.e., local) regulations. Data from other vehicle sensor subsystems 144 may be provided to the compliance module 166 so that the best course of action in light of the AV's status may be appropriately determined and performed. Alternatively, or additionally, the compliance module 166 may determine the course of action in conjunction with another operational or control module, such as the driving operation module 168.

The memory 175 may contain additional instructions as well, including instructions to transmit data to, receive data from, interact with, or control one or more of the vehicle drive subsystem 142, the vehicle sensor subsystem 144, and the vehicle control subsystem 146 including the autonomous Control system. The in-vehicle control computer 150 may control the function of the vehicle 105 based on inputs received from various vehicle subsystems (e.g., the vehicle drive subsystem 142, the vehicle sensor subsystem 144, and the vehicle control subsystem 146). Additionally, the in-vehicle control computer 150 may send information to the vehicle control subsystems 146 to direct the trajectory, velocity, signaling behaviors, and the like, of the vehicle 105. The autonomous control vehicle control subsystem may receive a course of action to be taken from the compliance module 166 of the in-vehicle control computer 150 and consequently relay instructions to other subsystems to execute the course of action.

The various methods described in the present document may be implemented on the vehicle 100 described with reference to FIG. 1. For example, one or more processors 170 may be configured to implement the object detection techniques described herein.

### 3. Introduction

LiDAR plays a major role in the field of autonomous driving. With the release of several large-scale multi-sensor datasets (e.g., the Waymo Open Dataset, and the nuScenes datasets, collected in real self-driving scenarios, LiDAR-based perception algorithms have significantly advanced in recent years. Thanks to the advancement of sparse convolution, voxel-based LiDAR perception methods have become predominant on major 3D object detection and semantic segmentation benchmarks, and outperform their point-based, pillar-based, or projection-based counterparts by a large margin in terms of both accuracy and efficiency. In voxel-based LiDAR perception networks, standard 3D sparse convolution is usually used in tandem with submanifold sparse convolution. Since standard 3D sparse convolution dilates the sparse features and increases the number of active sites, it is usually only applied as downsampling layer at each stage of the encoder followed by the submanifold sparse convolution layers. The submanifold sparse convolution maintains the number of active sites but it limits the information flow and the receptive field. However, a large receptive field is necessary to exploit the global contextual information, which is critical for 3D segmentation tasks.

In LiDAR-based perception, 3D object detection, semantic segmentation, and panoptic segmentation are usually implemented in distinct and specialized network architectures, which are task-specific and difficult to adapt to other LiDAR perception tasks. Multi-task networks, unify closely-related tasks by sharing the weights and computation among them and therefore expected to improve the performance of individual tasks while reducing the overall computational cost.

However, so far prior LiDAR multi-task networks have been underperforming compared to their single-task counterparts and have been failing to demonstrate state-of-the-art performance. As a result, single-task networks are still predominant in major LiDAR perception benchmarks.

In this document, we bridge the gap between the performance of single LiDAR multi-task networks and multiple independent task-specific networks. Specifically, we propose to unify 3D semantic segmentation, 3D object detection, and panoptic segmentation in a versatile network that exploits the synergy between these tasks and achieves state-of-the art performance.

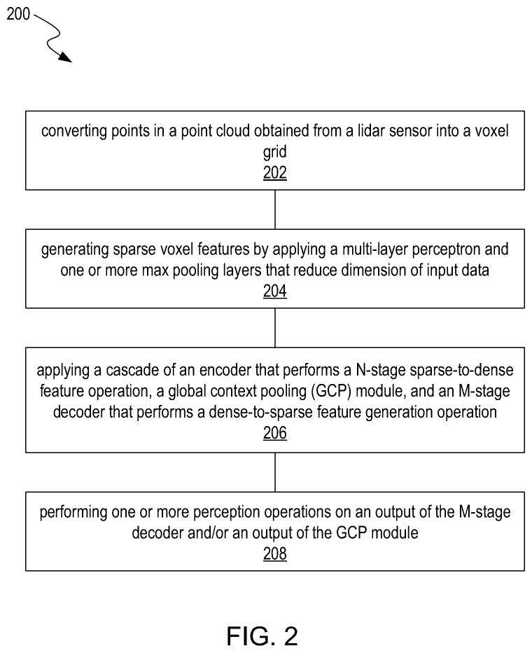

As further disclosed in the present document, in some embodiments, a method 200 depicted in FIG. 2 may include converting (202) points in a point cloud obtained from a lidar sensor into a voxel grid.

The method 200 further includes generating (204), from the voxel grid, sparse voxel features by applying a multi-layer perceptron and one or more max pooling layers that reduce dimension of input data;

The method 200 further includes applying (206) a cascade of an encoder that performs a N-stage sparse-to-dense feature operation, a global context pooling (GCP) module, and an M-stage decoder that performs a dense-to-sparse feature generation operation, wherein the GCP module bridges an output of a last stage of the N-stages with an input of a first stage of the M-stages, where N and M are positive integers; and wherein the GCP module comprises a multi-scale feature extractor.

The method 200 further includes performing (208) one or more perception operations on an output of the M-stage decoder and/or an output of the GCP module.

Further features and details of the method 200 are described in sections 4 to 20 of the present document.

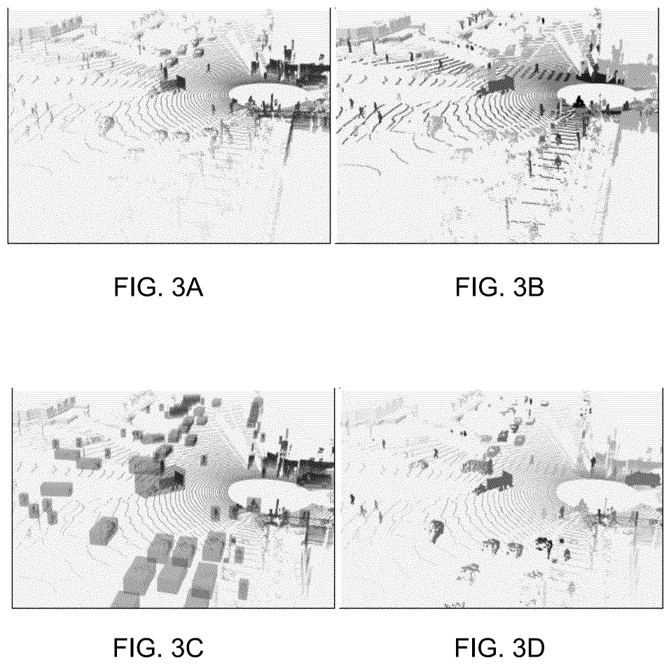

FIGS. 3A-3D show an example of effectiveness of the above-described method of a test scene.

FIG. 3A shows an example of a point cloud as input.

FIG. 3B shows an example simultaneous 3D semantic segmentation of point cloud in FIG. 3A.

FIG. 3C shows a result of 3D object detection on point cloud of FIG. 3A.

FIG. 3D shows an example of panoptic segmentation of point cloud in FIG. 3A.

Some example technical aspects are summarized below:

We present a novel voxel-based LiDAR multi-task network that unifies three major LiDAR perception tasks and can be extended for new tasks with little increase in the computational cost by adding more task-specific heads.

We propose a Global Context Pooling (GCP) module to improve the global feature learning in the encoder-decoder network based on 3D sparse convolution.

We introduce a second-stage refinement module to refine the first-stage semantic segmentation of the foreground thing classes and produce accurate panoptic segmentation results.

We demonstrate state-of-the-art performance for LidarMultiNet on 5 major LiDAR benchmarks. Notably, LidarMultiNet reaches the official 1^{st} place in the Waymo 3D semantic segmentation challenge 2022. LidarMultiNet reaches the highest mAPH (mean average precision weighted by heading accuracy) L2 for a single model on the Waymo 3D object detection benchmark. On the nuScenes semantic segmentation and panoptic segmentation benchmarks, LidarMultiNet outperforms the previously published state-of-the-art methods. On the nuScenes 3D object detection benchmark, LidarMulti-Net sets a new standard for state-of-the-art performance in LiDAR-only non-ensemble methods.

### 4. Some Technical Concepts

### 4.1 LiDAR Detection and Segmentation Examples

One key challenge for LiDAR perception is how to efficiently encode the large-scale sparsely distributed point cloud into a uniform feature representation. The common practice is transforming the point cloud into a discretized 3D or 2D map through a 3D voxelization, Bird's Eye View (BEV) projection, or range-view projection. State-of-the-art LiDAR 3D object detectors typically project the 3D sparse tensor into a dense 2D BEV feature map and perform the detection on the BEV space. In contrast, LiDAR segmentation requires predicting the pointwise labels, hence a larger features map is needed to minimize the discretization error when projecting the voxel labels back to the points. Many methods also combine the point-level features with voxel features to retain grained features in a multi-view fusion manner.

In LiDAR-based 3D object detection, anchor-free detectors are predominant on major detection benchmarks and widely adopted for their efficiency. Our LidarMultiNet adopts the anchor-free detection heads, which are attached to its 2D branch.

A second stage is often used in the detection framework to improve the detection accuracy through an RCNN-style network (region based convolutional neural network). It processes each object separately by extracting the features based on the initial bounding box prediction for refinement. LidarMultiNet adopts a second segmentation refinement stage based on the detection and segmentation results of the first stage.

### 4.2 LiDAR Panoptic Segmentation Examples

Recent LiDAR panoptic segmentation methods usually derive from the well-studied segmentation networks in a bottom-up fashion. This is largely due to the loss of height information in the detection networks, which makes them difficult to adjust the learned feature representation to the segmentation task. This results in two incompatible designs for the best segmentation and detection methods. End-to-end LiDAR panoptic segmentation methods still underperform compared to independently combined detection and segmentation models. In this work, our model can perform simultaneous 3D object detection and semantic segmentation and trains the tasks jointly in an end-to-end fashion.

### 4.3 Multi-Task Network Examples

Multi-task learning aims to unify multiple tasks into a single network and train them simultaneously in an end-to-end fashion. MultiNet is a seminal work of image-based multi-task learning that unifies object detection and road understanding tasks in a single network. In LiDAR-based perception, LidarMTL proposed a simple and efficient multi-task network based on 3D sparse convolution and deconvolutions for joint object detection and road understanding. In this work, we unify the major LiDAR-based perception tasks in a single, versatile, and strong network.

### 4.4 LidarMultinet Examples

Given a set of LiDAR point cloud P={pᵢ|pᵢϵ [symbol] ^{3+c}}ᵢ₌₁^{N}, where N is the number of points and each point has 3+c input features, the goals of the LiDAR object detection, semantic segmentation, and panoptic segmentation tasks are to predict the 3D bounding boxes, point-wise semantic labels Lₛₑₘ of K classes, and panoptic labels Lₚₐₙ, respectively.

Compared to semantic segmentation, panoptic segmentation additionally requires the points in each instance to have a unique instance id.

### 5. Architecture of Example Embodiments

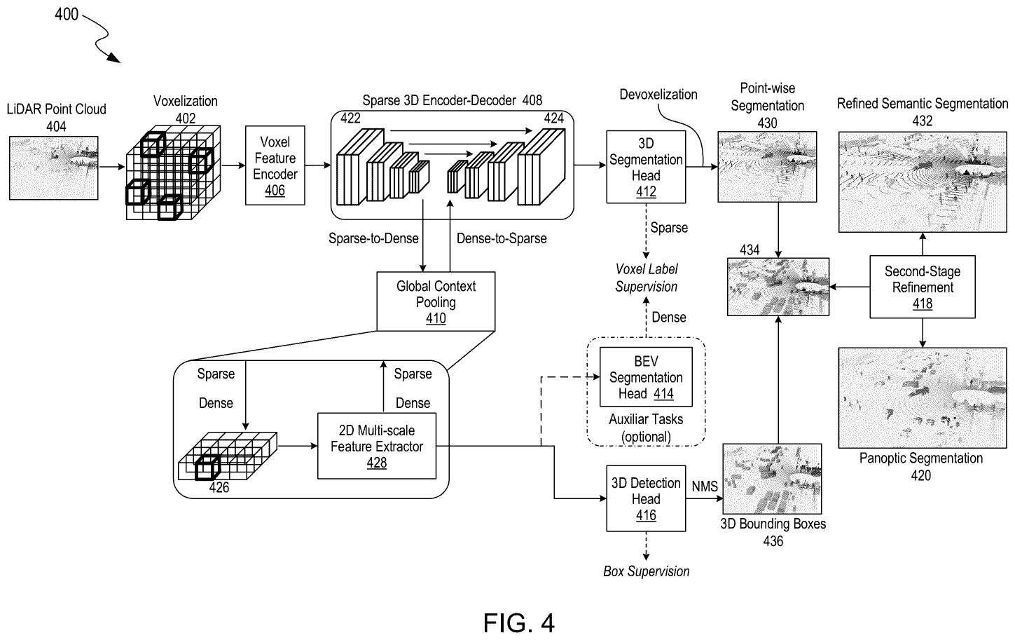

The main architecture 400 of LidarMultiNet is illustrated in FIG. 4. A voxelization step 402 converts the original unordered Li-DAR points (404) to a regular voxel grid. A Voxel Feature Encoder (VFE) 406 consisting of a Multi-Layer Perceptron (MLP) and max pooling layers is applied to generate enhanced sparse voxel features, which serve as the input to the 3D sparse U-Net architecture 408. Lateral skip-connected features from the encoder are concatenated with the corresponding voxel features in the decoder. A Global Context Pooling (GCP) module 410 with a 2D multi-scale feature extractor bridges the last encoder stage and the first decoder stage. 3D segmentation head 412 is attached to the decoder and outputs voxel-level predictions, which can be projected back to the point level through the de-voxelization step (430). Heads of BEV tasks 414, 416, such as 3D object detection (416), are attached to the 2D BEV branch. Given the detection and segmentation results of the first stage (436 and 430, merged into 434), the second stage 418 is applied to refine semantic segmentation 432 and generate panoptic segmentation results (420).

The 3D encoder 422 consists of 4 stages of 3D sparse convolutions with increasing channel width. Each stage starts with a sparse convolution layer followed by two submanifold sparse convolution blocks. The first sparse convolution layer has a stride of 2 except at the first stage, therefore the spatial resolution is downsampled by 8 times in the encoder. The 3D decoder 424 also has 4 symmetrical stages of 3D sparse deconvolution blocks but with decreasing channel width except for the last stage. We use the same sparse convolution key indices between the encoder and decoder to keep the same sparsity of the 3D voxel feature map.

For the 3D object detection task, we adopt the detection head of the anchor-free 3D detector CenterPoint and attach it to the 2D multi-scale feature extractor. Besides the detection head, an additional BEV segmentation head also can be attached to the 2D branch of the network, providing coarse segmentation results and serving as an auxiliary loss during the training.

### 6. Global Context Pooling Examples

3D sparse convolution drastically reduces the memory consumption of the 3D CNN for the LiDAR point cloud data, but it generally requires the layers of the same scale to retain the same sparsity in both encoder and decoder. This restricts the network to use only submanifold convolution in the same scale. However, submanifold convolution cannot broadcast features to isolated voxels through stacking multiple convolution layers. This limits the ability of CNN to learn long-range global information. Inspired by the Region Proposal Network (RPN) in the 3D detection network, we design a Global Context Pooling (GCP) module to extract large-scale information through a dense BEV feature map. On the one hand, GCP can efficiently enlarge the receptive field of the network to learn global contextual information for the segmentation task. On the other hand, its 2D BEV dense feature can also be used for 3D object detection or other BEV tasks, by attaching task-specific heads with marginal additional computational cost.

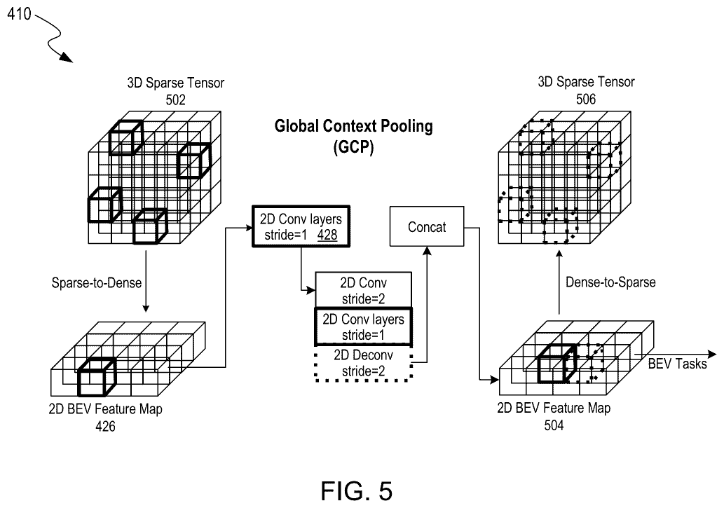

As illustrated in FIG. 5, given the low-resolution feature representation of the encoder output, we first transform the sparse voxel feature (502) into a dense feature map (504)

$${F}_{encoder}^{sparse} ∈ {ℝ}^{{C}^{′} \times {M}^{′}} \to {F}^{d e n s e} ∈ {ℝ}^{{C}^{′} \times \frac{D}{{d}_{z}} \times \frac{H}{{d}_{x}} \times \frac{W}{{d}_{y}}} ,$$

where d is the downsampling ratio and M′ is the number of valid voxels in the last scale. We concatenate the features in different heights together to form a 2D BEV (426) feature map

$${F}_{i n}^{b e v} ∈ {ℝ}^{( {C}^{′} * \frac{D}{{d}_{z}} ) \times \frac{H}{{d}_{x}} \times \frac{W}{{d}_{y}}} .$$

Then, we use a 2D multi-scale CNN (428) to further extract long-range contextual information. Note that we can utilize a deeper and more complex structure with a trivial run-time overhead, since the BEV feature map has a relatively small resolution. Lastly, we reshape the encoded BEV feature representation to the dense voxel map (504), then transform it to the sparse voxel feature (506) following the reverse dense to sparse conversion. Benefiting from GCP, our architecture could significantly enlarge the receptive field, which plays an important role in semantic segmentation. In addition, the BEV feature maps in GCP can be shared with other tasks (e.g., object detection) simply by attaching additional heads with slight increase of computational cost. By utilizing the BEV-level training like object detection, GCP can enhance the segmentation performance furthermore.

### 7. Multi-Task Training and Losses

The 3D segmentation branch predicts voxel-level labels L^{v}={lⱼ|lⱼϵ(1 . . . . K)}ⱼ₌₁^{M} given the learned voxel features F_{decoder}^{sparse}ϵ [symbol] ^{C×M} output by the 3D decoder. M stands for the number of active voxels in the output and C represents the dimension of every output feature. We supervise it through a combination of cross-entropy loss and Lovasz loss: L_{SEG}=L_{ce}^{v}+L_{Lovasz}^{v}. Note that L_{SEG} is a sparse loss, and the computational cost as well as the GPU memory usage are much smaller than dense loss.

The detection heads are applied on the 2D BEV feature map:

$${F}_{o u t}^{b e v} ∈ {ℝ}^{{C}_{b e v} \times \frac{H}{{d}_{x}} \times \frac{W}{{d}_{y}}} .$$

They predict a class-specific heatmap, the object dimensions and orientation, and a IoU rectification score, which are supervised by the focal loss (Lin et al. 2017) (Lₕₘ) and L1 loss (L_{reg}, Lᵢₒᵤ) respectively: L_{DET}=λₕₘLₕₘ+λ_{reg}L_{reg}+λᵢₒᵤLᵢₒᵤ, where the weights λₕₘ, λ_{reg}, λᵢₒᵤ are empirically set to [1,2,1].

During training, the BEV segmentation head is supervised with L_{BEV}, a dense loss consisting of cross-entropy loss and Lovasz loss: L_{BEV}=L_{ce}^{bev}+L_{Lovasz}^{bev}.

Our network is trained end-to-end for multiple tasks. Similar to (Feng et al. 2021), we define the weight of each component of the final loss based on the uncertainty (Kendall, Gal, and Cipolla 2018) as follows:

$${L}_{total} = {\sum }_{{L}_{i} ∈ \{ \begin{matrix}{L}_{c e}^{v} , {L}_{L o v a s z}^{v} , {L}_{ce}^{b e v} , \\ {L}_{L o v a s z}^{b e v} , {L}_{hm} , {L}_{r e g} , {L}_{i o u}\end{matrix} \}} \frac{1}{2 {σ}_{i}^{2}} {L}_{i} + \frac{1}{2} log {σ}_{i}^{2} \qquad ( 1 )$$

where σᵢ is the learned parameter representing the degree of uncertainty in taskᵢ. The more uncertain the taskᵢ is, the less Lᵢ contributes to Lₜₒₜₐₗ. The second part can be treated as a regularization term for σᵢ during training.

Instead of assigning an uncertainty-based weight to every single loss, we first group the losses belonging to the same task with fixed weights. The resulting three task-specific losses (i.e., L_{SEG}, L_{DET}, L_{BEV}) are then combined using weights defined based on the uncertainty:

$${L}_{total} = {\sum }_{i ∈ \{ SEG , DET , BEV \}} \frac{1}{2 {σ}_{i}^{2}} {L}_{i} + \frac{1}{2} log {σ}_{i}^{2} \qquad ( 2 )$$

### 8. Second-Stage Refinement

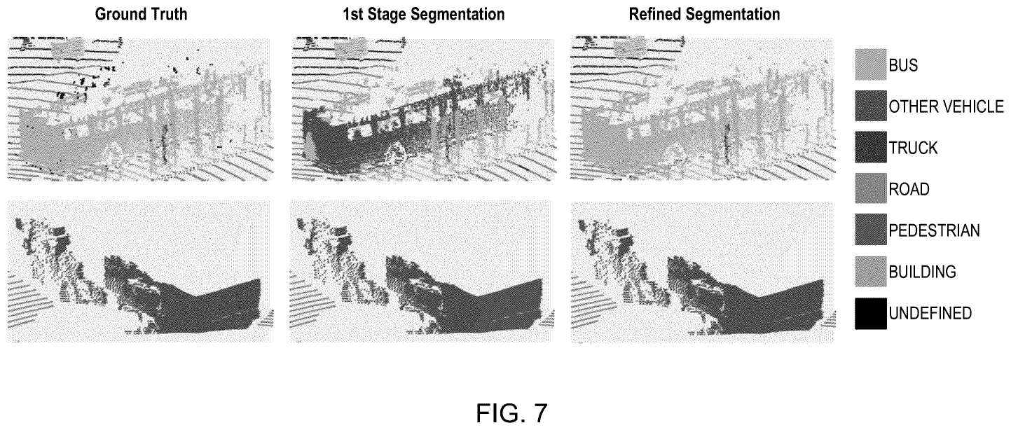

Coarse panoptic segmentation result can be obtained directly by fusing the first-stage semantic segmentation and object detection results, i.e., assigning a unique ID to the points classified as one of the foreground thing classes within a 3D bounding box. However, the points within a detected bounding box can be misclassified as multiple classes due to the lack of spatial prior knowledge, as shown in FIG. 7. In order to improve the spatial consistency for the thing classes, we propose a novel point-based approach as the second stage to refine the first-stage segmentation and provide accurate panoptic segmentation.

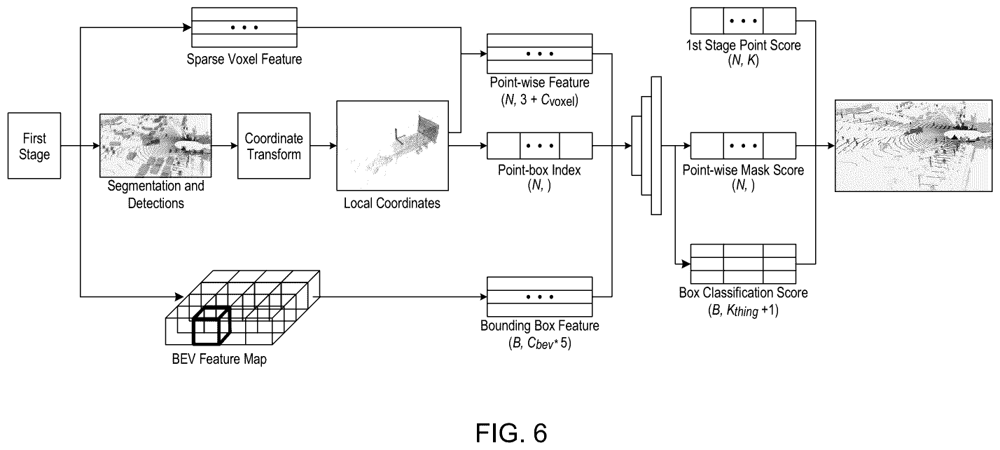

The second stage is illustrated in FIG. 6. Specifically, it takes features from raw point cloud P, the B predicted bounding boxes, sparse voxel features F_{decoder}^{sparse}, and the BEV feature map Fₒᵤₜ^{bev} to predict box classification scores S_{box} and point-wise mask scores Sₚₒᵢₙₜ. Given the B bounding box predictions in the 1st stage, we first transform each point within a box into its local coordinates. Then we concatenate its local coordinates with the corresponding voxel features from F_{decoder}^{sparse}. Meanwhile, we extract 2nd-stage box-wise features as in from F^{bev}. We assign a point-box index I={indᵢ|indᵢϵ [symbol] , 0≤indᵢ≤B}ᵢ₌₁^{N} to the points in each box. The points that are not in any boxes are assigned with index ϕ and will not be refined in the 2nd stage. Next, we use a PointNet-like network to predict point-wise mask scores Sₚₒᵢₙₜ={spᵢ|spᵢϵ(0,1)}ᵢ₌₁^{N} and box classification scores S_{box}={sbᵢ|sbᵢϵ(0,1)^{K}^{_{thing}}⁺¹}ᵢ₌₁^{B}, where K_{thing} denotes the number of thing classes and the one additional class represents the remaining stuff classes ∅. During training, we supervise the box-wise class scores through a cross-entropy loss and the point-wise mask scores through a binary cross-entropy loss.

We merge the 2nd-stage predictions with the 1st-stage semantic scores to generate the final semantic segmentation predictions \hat{L}ₛₑₘ. To refine segmentation score S_{2nd}={rsᵢ|rsᵢϵ(0,1)^{K}^{_{thing}}⁺¹}ᵢ₌₁^{N}, we combine the point-wise mask scores with their corresponding box-wise class scores as follows:

$${S}_{2 n d} ( j ) = \{ \begin{matrix}{S}_{point} \times {S}_{box} ( j ) , & j ∈ {I}^{{K}_{thing}} \\ {S}_{point} \times {S}_{box} ( j ) + ( 1 - {S}_{point} ) , & j = ∅\end{matrix} \qquad ( 3 )$$

where K_{thing} denotes the number of thing classes, ∅ denotes the rest stuff classes which would not be refined in the 2nd stage, Sₚₒᵢₙₜ={spᵢ|spᵢϵ(0,1)}ᵢ₌₁^{N} is the point-wise mask scores, and S_{box}={sbᵢ|sbᵢϵ(0,1)^{K}^{_{thing}}⁺¹}ᵢ₌₁^{B} is the box classification scores. N and B denote the number of points and boxes.

In addition, the points not in any boxes can be considered as S_{2nd}(∅)=1, which means their scores are the same as the 1st-stage scores. We then further combine the refined scores with the 1st-stage scores as follows:

$${S}_{final} = \{ \begin{matrix}{S}_{1 st} \times {S}_{2 nd} ( ∅ ) + {S}_{2 nd} \text{(*} ) , & {ind}_{i} \neq σ , * \neq ∅ \\ {S}_{1 st} , & {ind}_{i} = ϕ\end{matrix} \qquad ( 4 )$$

where ϕ denotes the index where points are not in any boxes, and S₁ₛₜ={sfᵢ|sfᵢϵ(0,1)ᵢ₌₁^{N}} is the 1st stage scores.

The scores S_{final} are used to generate the semantic segmentation results \hat{L}ₛₑₘ through finding the class with the maximum score. It is intuitive to infer the final panoptic segmentation results through the 1st-stage boxes and the final semantic segmentation results S_{box} and \hat{L}ₛₑₘ. First, we extract points for a box where points and the box have the same semantic category. Then the extracted points will be assigned a unique index as the instance id for the panoptic segmentation.

### 9. Discussion of Experimental Results

In this section, we perform extensive tests of the proposed LidarMultiNet on five major benchmarks of the large-scale Waymo Open Dataset (3D Object Detection and 3D Semantic Segmentation) and nuScenes dataset (Detection, LiDAR Segmentation, and Panoptic Segmentation).

FIG. 4 is a block diagram showing an architecture of a workflow. At the core of our network is a 3D encoder-decoder based on 3D sparse convolution and deconvolutions. In between the encoder and the decoder, a Global Context Pooling (GCP) module is applied to extract contextual information through the conversion between sparse and dense feature maps and via a 2D multi-scale feature extractor. The 3D segmentation head is attached to the decoder and its predicted voxel labels are projected back to the point level via a de-voxelization step. Meanwhile, the 3D detection head and auxiliary BEV segmentation head are attached to the 2D BEV branch. The 2nd-stage produces the refined semantic segmentation and the panoptic segmentation results.

### 10. Datasets and Metrics

Waymo Open Dataset (WOD) contains 1150 sequences in total, split into 798 in the training set, 202 in the validation set, and 150 in the test set. Each sequence contains about 200 frames of LiDAR point cloud captured at 10 FPS with multiple LiDAR sensors. Object bounding box annotations are provided in each frame while the 3D semantic segmentation labels are provided only for sampled frames. WOD uses Average Precision Weighted by Heading (APH) as the main evaluation metric for the detection task. There are two levels of difficulty, LEVEL 2 (L2) is assigned to examples where either the annotators label as hard or if the example has less than 5 LiDAR points, while LEVEL 1 (L1) is assigned to the rest of the examples. Both L1 and L2 examples partition of the primary metric mAPH L2.

For the semantic segmentation task, we use the v1.3.2 dataset, which contains 23,691 and 5,976 frames with semantic segmentation labels in the training set and validation set, respectively. There are a total of 2,982 frames in the final test set. WOD has semantic labels for a total of 23 classes, including an undefined class. Intersection Over Union (IOU) metric is used as the evaluation metric.

NuScenes contains 1000 scenes with 20 seconds duration each, split into 700 in the training set, 150 in the validation set, and 150 in the test set. The sensor suite contains a 32-beam LiDAR with 20 Hz capture frequency. For the object detection task, the key samples are annotated at 2 Hz with ground truth labels for 10 foreground object classes (thing). For the semantic segmentation and panoptic segmentation tasks, every point in the keyframe is annotated using 6 more background classes (stuff) in addition to the 10 thing classes. NuScenes uses mean Average Precision (mAP) and NuScenes Detection Score (NDS) metrics for the detection task, mIoU and Panoptic Quality (PQ) (Kirillov et al. 2019) metrics for the semantic and panoptic segmentation. Note that nuScenes panoptic task ignores the points that are included in more than one bounding box. As a result, the mIoU evaluation is typically higher than using full semantic labels.

### 11. Additional Implementation Details

On the Waymo Open Dataset, the point cloud range is set to [−75.2m, 75.2m] for x axis and y axis, and [−2m, 4m] for the z axis, and the voxel size is set to (0.1m, 0.1m, 0.15m). We transform the past two LiDAR frames using the vehicle's pose information and merge them with the current LiDAR frame to produce a denser point cloud and append a timestamp feature to each LiDAR point. Points of past LiDAR frames participate in the voxel feature computation but do not contribute to the loss calculation.

On the nuScenes dataset, the point cloud range is set to [−54m, 54m] for x axis and y axis, and [−5m, 3m] for the z axis, and the voxel size is set to (0.075m, 0.075m, 0.2m).

Following the common practice on nuScenes, we transform and concatenate points from the past 9 frames with the current point cloud to generate a denser point cloud. We apply separate detection heads in the detection branch for different categories.

During training, we employ data augmentation which includes standard random flipping, and global scaling, rotation and translation. We also adopt the ground-truth with the fade strategy. We train the models using AdamW optimizer with one-cycle learning rate policy, with a max learning rate of 3e-3, a weight decay of 0.01, and a momentum ranging from 0.85 to 0.95. We use a batch size of 2 on each of the 8 A100 GPUs. For the one-stage model, we train the models from scratch for 20 epochs. For the two-stage model, we freeze the 1st stage and finetune the 2nd stage for 6 epochs.

### 12. Another Dataset Result

### 12.1 3D Semantic Segmentation Challenge Leaderboard

We tested the performance of LidarMultiNet on the WOD 3D Semantic

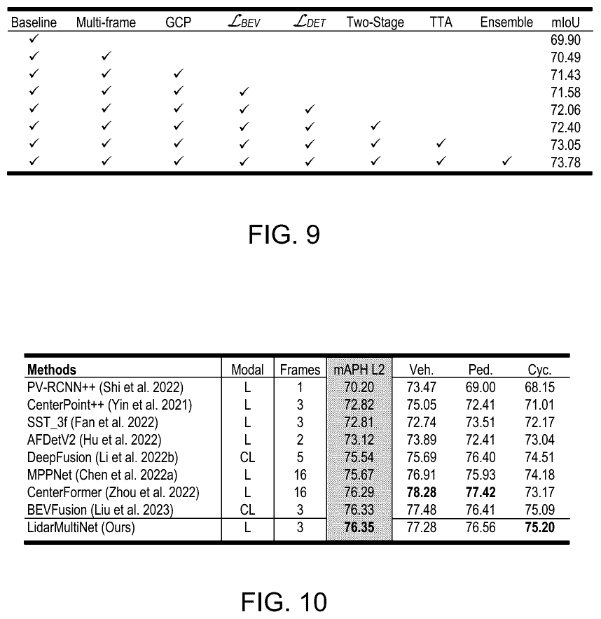

Segmentation Challenge. Since the semantic segmentation challenge only considers semantic segmentation accuracy, our model is trained with focus on semantic segmentation, while object detection and BEV segmentation both serve as the auxiliary tasks. Since there is no runtime constraint, most participants employed the Test-Time Augmentation (TTA) and model ensemble to further improve the performance of their methods. For details regarding the TTA and ensemble, please refer to the supplementary material. Table 1 in FIG. 9 is the final WOD semantic segmentation leaderboard and shows that our LidarMultiNet achieves a mIoU of 71.13 and ranks the 1^{st} place on the leaderboard, and also has the best IoU for 15 out of the total 22 classes. Note that our LidarMultiNet uses only LiDAR point cloud as input, while some other entries on the leaderboard (e.g., SegNet3DV2) use both LiDAR points and camera images and therefore require running additional 2D CNNs to extract image features.

For a better reference, we also test the result of LidarMultiNet that is trained with both detection and segmentation as the main tasks. LidarMultiNet reaches a mIoU of 69.69 onWOD 3D segmentation test set without TTA and model ensemble.

### 12.2 Ablation Study on the 3D Semantic Segmentation Validation Set

We ablate each component of the LidarMulti-Net and the results on the 3D semantic segmentation validation set are shown in Table 2 (FIG. 10). Our baseline network reaches a mIoU of 69.90 on the validation set. On top of this baseline, multi-frame input (i.e., including the past two frames) brings a 0.59 mIoU improvement. The GCP further improves the mIoU by 0.94. The auxiliary losses (i.e., BEV segmentation and 3D object detection) result in a total improvement of 0.63 mIoU, and the 2nd-stage improves the mIoU by 0.34, forming our best single model on the WOD validation set. TTA and ensemble further improve the mIoU to 73.05 and 73.78, respectively.

### 12.3 Evaluation on the 3D Object Detection Benchmark

To demonstrate that LidarMultiNet can outperform single-task models on both detection and segmentation tasks, we tested it on the WOD 3D object detection benchmark and compared with state-of-the-art 3D object detection methods. The model is trained with both detection and segmentation as the main tasks, and its detection head is trained for detecting three classes (i.e., vehicle, pedestrian, and cyclist).

The model is trained for 20 epochs with the fade strategy, i.e., ground-truth sampling for the object detection task is disabled for the last 5 epochs. The results on WOD test and validation set are shown in Table 3 and Table 4. Our LidarMultiNet method reaches the highest mAPH L2 of 76.35 on the test set for a single model without TTA and outperforms the state-of-art 3D object detectors, including the multi-modal detectors which also leverage camera information. LidarMultiNet also outperforms other multi-frame fusion methods that require more past frames. Moreover, the same LidarMultiNet model reaches a mIoU of 71.93 on the WOD semantic segmentation validation set. In comparison, the other detectors and segmentation methods on the WOD benchmarks are all single-task models dedicated for either object detection or semantic segmentation.

### 12.4 Effect of the Joint Multi-task Training

Table 5 (FIG. 12) shows an ablation study comparing the first-stage result of the jointly-trained model with independently-trained models. The segmentation-only model removes the detection head, while keeping only the 3D segmentation head and the BEV segmentation head. The detection-only model keeps only the detection head. Compared to the single-task models, the jointly-trained model performs better on both segmentation and detection. In addition, by sharing part of the network among the tasks, the jointly-trained model is also more efficient that directly combining the independent single-task models.

### 13. NuScenes Benchmarks

13.1 Comparison with State-of-the-Art Methods

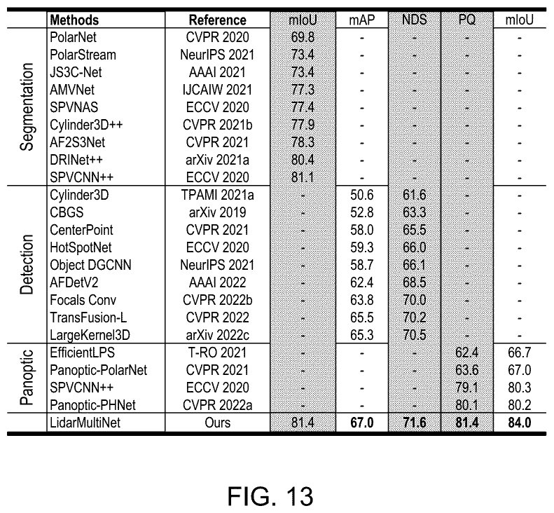

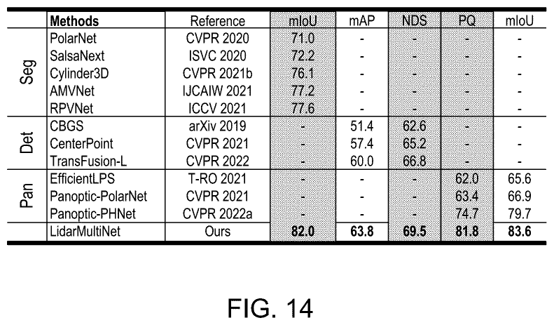

On the nuScenes detection, semantic segmentation, and panoptic segmentation benchmarks, we compare LidarMultiNet with state-of-the-art LiDAR-based methods. The test set and validation set results of all three benchmarks are summarized in Table 6 and Table 7 (FIG. 13, FIG. 14) respectively. As shown in the tables, a single-model LidarMultiNet without TTA outperforms the previous state-of-the-art methods on each task. Combining the independently trained state-of-the-art single-task models (i.e., DRINet++, LargeKernel3D, and Panoptic-PHNet) reaches 80.4 mIOU, 70.5 NDS, and 80.2 PQ on the test set. In comparison, one single LidarMultiNet model without TTA outperforms their combined performance by 1.0% in mIOU, 1.1% in NDS, and 1.3% in PQ.

In summary, to the best of our knowledge, LidarMultiNet is the first time that a single LiDAR multi-task model surpasses previous single-task state-of-the-art methods for the three major LiDAR-based perception tasks.

### 14. Effect of the Second-Stage Refinement

An ablation study on the effect of the proposed 2nd stage is shown in Table 8. With the 1st-stage detection and semantic predictions, LidarMultiNet already can get high panoptic segmentation results by directly fusing these two results together. The proposed 2nd stage further improves both semantic segmentation and panoptic segmentation results.

### 15. Top-Down LiDAR Panoptic Segmentation

CNN-based top-down panoptic segmentation methods have shown competitive performance compared to the bottom-up methods in the image domain. However, most previous LiDAR panoptic segmentation methods adopt the bottom-up design due to the need of an accurate semantic prediction. And the cumbersome network structures with multi-view or point-level features fusion make them difficult to perform well in the object detection task. On the other hand, thanks to the GCP module and joint training design, LidarMultiNet can reach top performance on both object detection and semantic segmentation tasks. Even without a dedicated panoptic head, LidarMultiNet already out previous state-of-the-art bottom-up method.

FIG. 5 is an example of a global context pooling module implementation. 3D sparse tensor is projected to a 2D BEV feature map. Two levels of 2D BEV feature maps are concatenated and then converted back to a 3D sparse tensor, which serves as the input to the BEV task heads.

FIG. 6 is an example of a second-stage refinement pipeline. The architecture of the second-stage refinement is point-based. We first fuse the detected boxes, voxel-wise features, and BEV features from the 1st stage to generate the inputs for the 2^{nd} stage. The local coordinate transformation is applied to the points within each box. Then, a point-based backbone with MLPs, attention modules, and aggregation modules infer the box classification scores and point-wise mask scores. The final refined segmentation scores are computed by fusing the 1st and 2nd stage predictions.

FIG. 7 shows example outputs of the second stage refinement. The segmentation consistency of points of the thing objects can be improved by the 2nd stage.

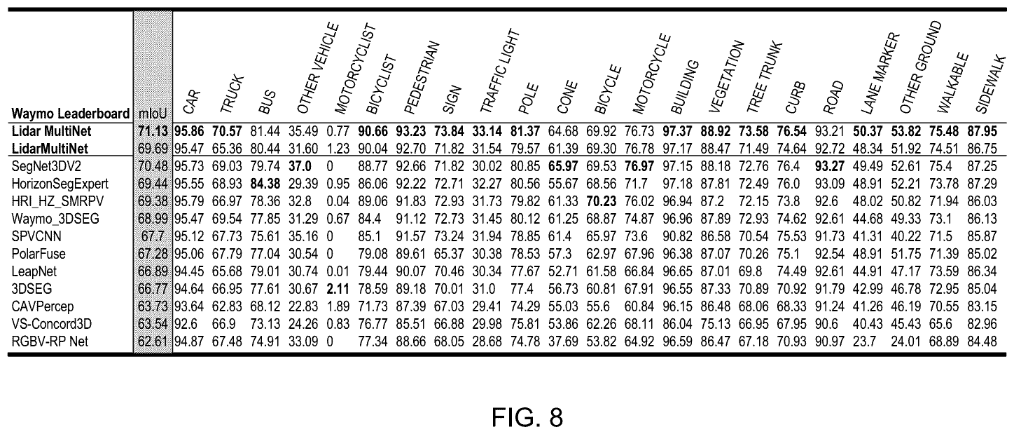

FIG. 8 shows Table 1 of Waymo Open Dataset Semantic Segmentation Leaderboard. Our LidarMultiNet reached the highest mIoU of 71.13 and achieved the best accuracy on 15 out of the 22 classes. y: without TTA and model ensemble.

FIG. 9 shows Table 2: Ablation studies for 3D semantic segmentation on the WOD validation set. We show the improvement introduced by each component compared to our LidarMultiNet base network.

FIG. 10 shows Table 3 Single-model detection performance comparisons on Waymo test set. “L” indicates LiDAR-only, and “CL” denotes camera and LiDAR fusion.

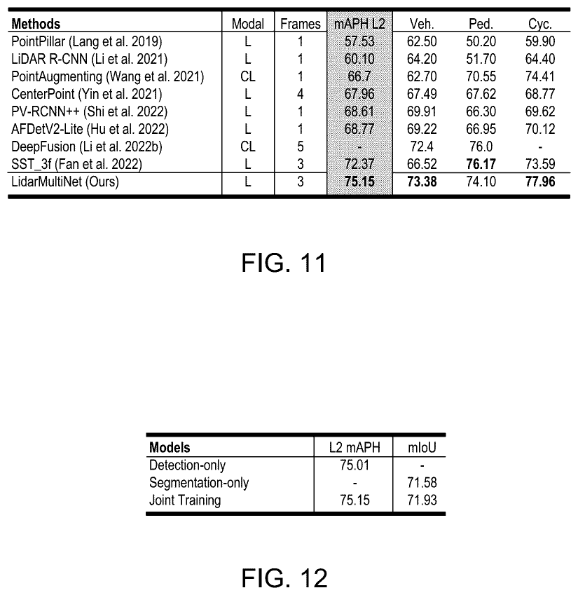

FIG. 11 shows Table 4: Detection performance comparisons on Waymo validation set. “L” indicates LiDAR-only, and “CL” denotes camera and LiDAR fusion.

FIG. 12 shows Table 5: Comparison of the first-stage result of the jointly trained model and independently trained single-task models.

FIG. 13 shows Table 6: Comparison with state-of-the-art methods on the test sets of three nuScenes benchmarks. A single LidarMultiNet model is used to generate predictions for all three tasks.

FIG. 14 shows Table 7: Comparison with state-of-the-art methods on the validation sets of three nuScenes benchmarks.

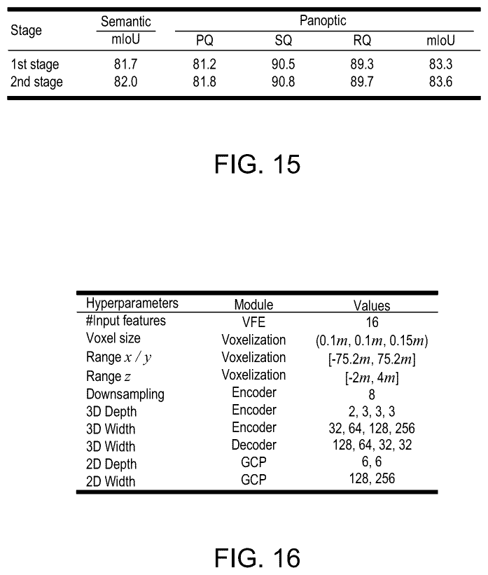

FIG. 15 shows Table 8: Improvements of the 2nd-stage segmentation refinement on the nuScenes semantic segmentation and panoptic segmentation validation sets.

FIG. 16 shows Table 9: Implementation details of the LidarMultiNet.

In the Waymo Open Dataset pose estimation challenge 2023, our proposed LPFormer secured the 1^{st} place. As for the future work, we plan to further enhance our LPFormer method through broad integration and fusion of LiDAR and camera data, in addition to exploiting 2D weak supervision. We present the LidarMultiNet, which reached the official 1st place in the Waymo Open Dataset 3D semantic segmentation challenge 2022. LidarMultiNet is the first multi-task network to achieve state-of-the-art performance on all five major large-scale LiDAR perception benchmarks. We hope our LidarMultiNet can inspire future works in the unification of all LiDAR perception tasks in a single, versatile, and strong multi-task network.

### 16. Network Hyperparameter Examples

Hyperparameters of LidarMultiNet are summarized in Table 9 (FIG. 16). Size of the input features of VFE is set to 16. The 3D encoder in our network has 4 stages of 3D sparse convolutions with increasing channel width 32, 64, 128, 256. The downsampling factor of the encoder is 8. The 3D decoder has 4 symmetrical stages of 3D sparse deconvolution blocks with decreasing channel widths 128, 64, 32, 32. 2D depth and width o re set to 6, 6 and 128, 256, respectively.

### 17. Test-Time Augmentation and Ensemble Examples

In order to further improve the performance on the WOD semantic segmentation benchmark, we apply Test-Time Augmentation (TTA). Specifically, we use flipping with respect to xz-plane and yz-plane, [0.95, 1.05] for global scaling, and [±22.5°, ±45°, ±135°, ±157.5°, 180°] for yaw rotation. Besides, we found pitch and roll rotation were helpful in the segmentation task, and we use ±8° for pitch rotation and ±5° for roll rotation. In addition, we also apply ±0.2m translation along z-axis for augmentation.

Besides the best single model, we also explored the network design space and designed multiple variants for model ensemble. For example, more models are trained with smaller voxel size (0.05m, 0.05m, 0.15m), smaller down-sample factor (4×), different channel width (64), without the 2nd stage, or with more past frames (4 sweeps). For our subboard, a total of 7 models are ensembled to generate the segmentation result on the test set.

### 18. Runtime and Model Size Examples

We tested the runtime and model size of LidarMultiNet on Nvidia A100 GPU. Compared with single-task models (nuScenes detection: 107 ms, segmentation: 112 ms, summation: 219 ms), our multi-task network shows notable efficiency (nuScenes the 1st stage runtime: 126 ms, model size: 135M, the 2nd stage runtime: 9 ms, model size: 4M, WOD the 1st stage runtime: 145 ms, model M, the 2nd stage runtime: 18 ms, model size: 4M)

### 19. Visualization Examples

Some example qualitative results of LidarMultiNet on the validation sets of Waymo Open Dataset and nuScenes dataset are visualized in FIG. 7 and FIG. 8, respectively.

### 20. A Listing of Preferred Technical Solutions

The following technical solutions may be adopted by some preferred embodiments.

1. A method of processing point cloud information, comprising: converting points in a point cloud obtained from a lidar sensor into a voxel grid; generating, from the voxel grid, sparse voxel features by applying a multi-layer perceptron and one or more max pooling layers that reduce dimension of input data; applying a cascade of an encoder that performs a N-stage sparse-to-dense feature operation, a global context pooling (GCP) module, and an M-stage decoder that performs a dense-to-sparse feature generation operation, wherein the GCP module bridges an output of a last stage of the N-stages with an input of a first stage of the M-stages, where N and M are positive integers; and wherein the GCP module comprises a multi-scale feature extractor; and performing one or more perception operations on an output of the M-stage decoder and/or an output of the GCP module.

2. The method of solution 1, wherein the one or more perception operations comprise obtaining a three-dimensional (3D) point-wise segmentation by attaching a 3D segmentation head to the output of a last stage of the M-stage decoder; obtaining voxel-level predictions at an output of the 3D segmentation head, and performing a de-voxelization on the voxel-level predictions to obtain point-wise segmentation results.

3. The method of solution 2, wherein the one or more perception operations comprise obtaining a panoptic segmentation by applying a second stage refinement to the point-wise segmentation results.

4. The method of solution 3, wherein the one or more perception operations comprise generating a panoptic segmentation result from the second stage refinement.

5. The method of any of solutions 1-4, wherein N=4, and wherein stages of the N-stages have increasing channel width.

6. The method of any of solutions 1-5, wherein each stage of the N-stage comprises a sparse convolution layer followed by two submanifold sparse convolution blocks.

7. The method of solution 6, wherein the sparse convolution layer of each of N-stages, except for first stage, has a stride of 2 such that spatial resolution is downsampled by a factor of 8 in the encoder.

8. The method of any of solutions 1-7, wherein M=4 such that the decoder comprises symmetrical stages of 3D sparse deconvolution blocks with decreasing channel width except for a last stage.

9. The method of any of solutions 4-8, wherein the second stage refinement is obtained by: fusing detected boxes, voxel-wise features and bird's eye view (BEV) features; applying a local coordinate transformation to points within each detected box; calculating box classification scores and point-wise mask scores; and determining output of the second stage refinement by fusing the box classification scores and point-wise mask scores and an output of a previous refinement stage.

10. The method of any of solutions 1-9, wherein the GCP module is configured to operate as: sparse voxel features into a dense feature map; generating a 2D BEV feature map by concatenating features in different heights; extracting long term contextual information by using a 2D convolutional neural network; reshaping encoded BEV feature representation to a dense voxel map; and transforming the dense voxel map to a sparse voxel by applying a dense-to-sparse conversion.

11. The method of solution 10, further including: using the 2D BEV feature map to perform object detection.

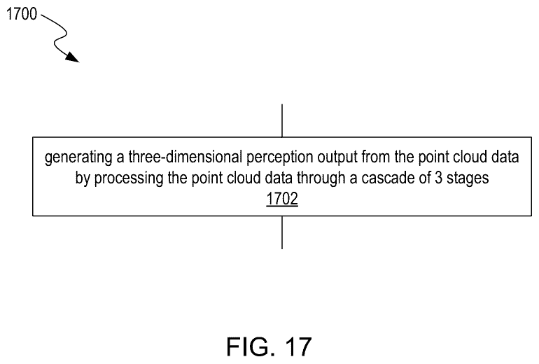

12. A method (e.g., method 1700 depicted in FIG. 17) of performing perception of a point cloud data obtained from a lidar, comprising: generating (1702) a three-dimensional perception output from the point cloud data by processing the point cloud data through a cascade of three stages, wherein the cascade includes: a first stage in which the point cloud data is encoded from a sparse representation to a dense representation; a second stage in which features are extracted from the dense representation using a long-range contextual information to identify the features; and a third stage in which the dense representation is transformed into a sparse representation from which the three-dimensional perception output is generated.

13. The method of solution 12, wherein the cascade of three stages comprises one or more perception operations comprising obtaining a three-dimensional (3D) point-wise segmentation by attaching a 3D segmentation head to the output of a last stage of an M-stage decoder; obtaining voxel-level predictions at an output of the 3D segmentation head, and performing a de-voxelization on the voxel-level predictions to obtain point-wise segmentation results.

14. The method of solution 13, wherein the one or more perception operations comprise obtaining a panoptic segmentation by applying a second stage refinement to the point-wise segmentation results.

15. The method of solution 14, wherein the one or more perception operations comprise generating a panoptic segmentation result from the second stage refinement.

16. The method of solutions 12, wherein the second stage comprises N stages having an increasing channel width.

17. The method of solution 16, wherein each stage of the N stages comprises a sparse convolution layer followed by two submanifold sparse convolution blocks.

18. The method of solution 17, wherein the sparse convolution layer of each of the N stages, except for first stage, has a stride of 2 such that spatial resolution is downsampled by a factor of 8 in the encoder.

19. The method of solutions 13-18, wherein M=4 such that the decoder comprises symmetrical stages of 3D sparse deconvolution blocks with decreasing channel width except for a last stage.

20. The method of any of solutions 15-19, wherein the second stage refinement is obtained by: fusing detected boxes, voxel-wise features and bird's eye view (BEV) features; applying a local coordinate transformation to points within each detected box; calculating box classification scores and point-wise mask scores; and determining output of the second stage refinement by fusing the box classification scores and point-wise mask scores and an output of a previous refinement stage.

21. The method of any of solutions 12-20, wherein the second stage is configured to operate as: sparse voxel features into a dense feature map; generating a 2D BEV feature map by concatenating features in different heights; extracting long term contextual information by using a 2D convolutional neural network; reshaping encoded BEV feature representation to a dense voxel map; and transforming the dense voxel map to a sparse voxel by applying a dense-to-sparse conversion.

22. The method of solution 21, further including: using the 2D BEV feature map to perform object detection.

23. An image processing apparatus comprising one or more processors configured to implement a method recited in any of solutions 1-22.

24. A computer-storage medium having process-executable code for implementing a method recited in any of solutions 1-22.

Additional details and examples of solutions 1 to 14 are disclosed in sections 4 to 20.

Implementations of the subject matter and the modules and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, e.g., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. In some implementations, however, a computer may not need such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

1. A method of processing point cloud information, comprising:
converting points in a point cloud obtained from a lidar sensor into a voxel grid;
generating, from the voxel grid, sparse voxel features by applying a multi-layer perceptron and one or more max pooling layers that reduce dimension of input data;
applying a cascade of an encoder that performs a N-stage sparse-to-dense feature operation, a global context pooling (GCP) module, and an M-stage decoder that performs a dense-to-sparse feature generation operation,
wherein the GCP module bridges an output of a last stage of the N-stages with an input of a first stage of the M-stages, where N and M are positive integers; and
wherein the GCP module comprises a multi-scale feature extractor; and
performing one or more perception operations on an output of the M-stage decoder and/or an output of the GCP module.

2. The method of claim 1, wherein the one or more perception operations comprise obtaining a three-dimensional (3D) point-wise segmentation by attaching a 3D segmentation head to the output of a last stage of the M-stage decoder; obtaining voxel-level predictions at an output of the 3D segmentation head, and performing a de-voxelization on the voxel-level predictions to obtain point-wise segmentation results.

3. The method of claim 2, wherein the one or more perception operations comprise obtaining a panoptic segmentation by applying a second stage refinement to the point-wise segmentation results.

4. The method of claim 3, wherein the one or more perception operations comprise generating a panoptic segmentation result from the second stage refinement.

5. The method of claim 1, wherein N=4, and wherein stages of the N-stages have increasing channel width.

6. The method of claim 1, wherein each stage of the N-stage comprises a sparse convolution layer followed by two submanifold sparse convolution blocks.

7. The method of claim 6, wherein the sparse convolution layer of each of N-stages, except for first stage, has a stride of 2 such that spatial resolution is downsampled by a factor of 8 in the encoder.

8. The method of claim 1, wherein M=4 such that the decoder comprises symmetrical stages of 3D sparse deconvolution blocks with decreasing channel width except for a last stage.

9. The method of claim 3, wherein the second stage refinement is obtained by:
fusing detected boxes, voxel-wise features and bird's eye view (BEV) features;
applying a local coordinate transformation to points within each detected box;
calculating box classification scores and point-wise mask scores; and
determining output of the second stage refinement by fusing the box classification scores and point-wise mask scores and an output of a previous refinement stage.

10. The method of claim 1, wherein the GCP module is configured to operate as:
sparse voxel features into a dense feature map;
generating a 2D BEV feature map by concatenating features in different heights;
extracting long term contextual information by using a 2D convolutional neural network;
reshaping encoded BEV feature representation to a dense voxel map; and
transforming the dense voxel map to a sparse voxel by applying a dense-to-sparse conversion.

11. A method of performing perception of a point cloud data obtained from a lidar, comprising:
generating a three-dimensional perception output from the point cloud data by processing the point cloud data through a cascade of three stages, wherein the cascade includes:
a first stage in which the point cloud data is encoded from a sparse representation to a dense representation;
a second stage in which features are extracted from the dense representation using a long-range contextual information to identify the features; and
a third stage in which the dense representation is transformed into a sparse representation from which the three-dimensional perception output is generated.

12. The method of claim 11, wherein the cascade of three stages comprises one or more perception operations comprising obtaining a three-dimensional (3D) point-wise segmentation by attaching a 3D segmentation head to the output of a last stage of an M-stage decoder;
obtaining voxel-level predictions at an output of the 3D segmentation head, and performing a de-voxelization on the voxel-level predictions to obtain point-wise segmentation results.

13. The method of claim 12, wherein the one or more perception operations comprise obtaining a panoptic segmentation by applying a second stage refinement to the point-wise segmentation results.

14. The method of claim 13, wherein the one or more perception operations comprise generating a panoptic segmentation result from the second stage refinement.

15. The method of claim 11, wherein the second stage comprises N stages having an increasing channel width.

16. The method of claim 15, wherein each stage of the N stages comprises a sparse convolution layer followed by two submanifold sparse convolution blocks.

17. The method of claim 16, wherein the sparse convolution layer of each of the N stages, except for first stage, has a stride of 2 such that spatial resolution is downsampled by a factor of 8 in the encoder.

18. The method of claim 14, wherein the second stage refinement is obtained by:
fusing detected boxes, voxel-wise features and bird's eye view (BEV) features;
applying a local coordinate transformation to points within each detected box;
calculating box classification scores and point-wise mask scores; and
determining output of the second stage refinement by fusing the box classification scores and point-wise mask scores and an output of a previous refinement stage.

19. The method of claim 11, wherein the second stage is configured to operate as:
sparse voxel features into a dense feature map;
generating a 2D BEV feature map by concatenating features in different heights;
extracting long term contextual information by using a 2D convolutional neural network;
reshaping encoded BEV feature representation to a dense voxel map; and
transforming the dense voxel map to a sparse voxel by applying a dense-to-sparse conversion.

20. An image processing apparatus comprising one or more processors configured to implement a method, comprising:
converting points in a point cloud obtained from a lidar sensor into a voxel grid;
generating, from the voxel grid, sparse voxel features by applying a multi-layer perceptron and one or more max pooling layers that reduce dimension of input data;
applying a cascade of an encoder that performs a N-stage sparse-to-dense feature operation, a global context pooling (GCP) module, and an M-stage decoder that performs a dense-to-sparse feature generation operation,
wherein the GCP module bridges an output of a last stage of the N-stages with an input of a first stage of the M-stages, where N and M are positive integers; and
wherein the GCP module comprises a multi-scale feature extractor; and
performing one or more perception operations on an output of the M-stage decoder and/or an output of the GCP module.
